(19) United States
(12) Patent Application Publication
(10) Pub. No.: US 2025/0010266 A1
(43) Pub. Date: Jan. 9, 2025

(54) PREPARATION METHOD AND APPLICATION OF RED MUD-ENHANCED MAGNETIC STRAW BIOCHAR MATERIAL

(71) Applicant: NANJING INSTITUTE OF ENVIRONMENTAL SCIENCES, MINISTRY OF ECOLOGY AND ENVIRONMENT, Nanjing (CN)

(72) Inventors: Xiaochen LIN, Nanjing (CN); Houhu ZHANG, Nanjing (CN); Shenghu ZHANG, Nanjing (CN); Yifan XU, Nanjing (CN); Zifei SUN, Nanjing (CN); Hongji GUO, Nanjing (CN); Xuejian LI, Nanjing (CN); Yuanshun XU, Nanjing (CN); Dapeng ZHANG, Nanjing (CN); Lili WANG, Nanjing (CN)

(73) Assignee: NANJING INSTITUTE OF ENVIRONMENTAL SCIENCES, MINISTRY OF ECOLOGY AND ENVIRONMENT, Nanjing (CN)

(21) Appl. No.: 18/705,618

(22) PCT Filed: Oct. 26, 2023
(86) PCT No.: PCT/CN2023/126748

§ 371 Date: Apr. 29, 2024

(30) Foreign Application Priority Data
Feb. 6, 2023 (CN) 202310101850.X

(51) Int. Cl. B01J 20/20; C02F 1/28; C02F 101/34; C02F 101/36; C02F 101/38

(52) U.S. Cl. CPC B01J 20/20; C02F 1/283; B01J 2220/46; B01J 2220/4806; B01J 2220/4825; C02F 2101/34; C02F 2101/36; C02F 2101/38; C02F 2303/18

(57) ABSTRACT

A preparation method and application of a red mud-enhanced magnetic straw biochar material includes the following steps of: naturally air-drying or artificial drying straws, and crushing the dried straws; drying red mud from Bayer process, and crushing the red mud into powder; then mixing the crushed straws and the powdery red mud by ball milling to prepare straw-red mud mixed powder; mixing water and biomass ash rich in alkali, and extracting the mixture to obtain a biomass ash extracting solution and dealkalized biomass ash solid residues; and uniformly mixing and stirring the straw-red mud mixed powder and the biomass ash extracting solution to obtain a pasty mixture, carrying out co-pyrolysis on the pasty mixture under a protective atmosphere, and washing magnetic straw biochar produced by co-pyrolysis with water until the magnetic straw biochar is neutral to obtain the red mud enhanced magnetic straw biochar material.

### TECHNICAL FIELD

The present invention belongs to the field of solid waste reuse, and particularly relates to a preparation method and application of a red mud-enhanced magnetic straw biochar material.

### BACKGROUND

About 900 million tons of straws are produced in China every year, and are mainly used as a fertilizer by returning to the field except for a small part used as feed, thus having little value. Biochar or activated carbon is a commonly used adsorbing material with a high value, but ordinary straw biochar has a low value due to a poor adsorption capacity. Straws and agricultural and forestry residues are partially used as biomass fuel to generate energy, and secondary residues produced in this process are mainly biomass ash. The biomass ash is alkaline and rich in nutrients such as phosphorus, magnesium and soluble silicon, may be used as a fertilizer, and can improve acidic soil at the same time. However, for alkaline soil in western and northern regions in China, the direct application of the biomass ash may aggravate soil salinization, which inhibits the comprehensive utilization of the biomass ash.

Red mud is non-ferrous metal residues with the maximum yield in China, 95% of the red mud is produced from Bayer process, and an annual yield of the red mud is about 120 million tons. Although the red mud from Bayer process contains a certain amount of iron oxide, the iron oxide is difficult to be separated and enriched, thus having no refining value, and having a comprehensive utilization rate lower than 5%. The storage of the red mud occupies a large amount of land, which causes environmental and safety hazards, so that it is urgent to find a way for comprehensive utilization of the red mud. Shandong and Henan provinces are not only the main producing regions of the red mud, but also the major grain-producing provinces, and if the straws and the red mud may be used synergistically, reuse and disposal of solid waste can be greatly promoted.

Fluoroquinolone antibiotics are a kind of universal drugs for human and animals because of being cheap, broad-spectrum antibacterial and not prone to drug resistance. However, the fluoroquinolone antibiotics are difficult to degrade in water, and the heavy use causes the accumulation of the antibiotics in the environment, which poses a great threat to the environment. Commonly used fluoroquinolone antibiotics comprise ofloxacin, norfloxacin, ciprofloxacin, pefloxacin, enoxacin, and the like. Adsorption is an important means to remove the fluoroquinolone antibiotics.

The straw biochar has a high ash content, a low specific surface area, a poor adsorption capacity and therefore a low economic value. Iron in the red mud is difficult to be enriched by beneficiation, thus having no smelting value, and being difficult to be comprehensively utilized. The red mud has a small specific surface area and an extremely low adsorption capacity to organic pollutants such as antibiotics, so that an adsorbing material prepared from the red mud is mainly used for inorganic pollutants such as heavy metals, and is rarely used for organic pollutants.

CN110586038B and CN109847697B provide a method for efficiently removing a pollutant by loading nano-zero-valent iron on biochar, but a ferric salt or a ferrous salt needs to be used as a raw material of the zero-valent iron in these methods, so that a manufacturing cost is high. CN107051413B and CN108543517B show a magnetic material produced by mixing red mud, a carbon source and a binder and then calcining the mixture in isolation of oxygen, which is used for enriching and recovering heavy metal ions in a wastewater, and shows the possibility of preparing a magnetic adsorbent from the red mud. The Chinese patent for invention with the publication number CN106362685A also discloses a method for removing arsenic from a water body by a co-pyrolysis product of red mud and biomass. CN113522238A introduces a red mud-based iron-carbon composite material, a preparation method thereof and an application thereof for removing a heavy metal in a wastewater, but the red mud needs to be treated with an acid solution for pre-dealkalization in this method, resulting in a large amount of acidic wastewater, and an adsorption performance of the composite material is not improved compared with original biochar. The above biochar materials have the defects of complicated preparation process and high cost, which are not conducive to the comprehensive utilization of solid wastes such as the straws and the red mud, and meanwhile, the prepared biochar material mainly aims at the heavy metal.

### SUMMARY

Object of invention: the technical problem to be solved by the present invention is to provide a preparation method of a red mud-enhanced magnetic straw biochar material aiming at the defects in the prior art, in which red mud, biomass ash and straws are synergistically utilized to improve a quality and value of a comprehensive utilization product, realize solid waste reuse, and generate economic benefits.

In order to achieve the above object, a technical solution adopted in the present invention is as follows.

A preparation method of a red mud-enhanced magnetic straw biochar material comprises the following steps of:
(1) naturally air-drying or artificial drying straws, and crushing the dried straws;
(2) drying red mud from Bayer process, and crushing the red mud into powder;
(3) mixing the crushed straws in the step (1) and the powdery red mud in the step
   (2) by ball milling to obtain straw-red mud mixed powder;
(4) mixing water and biomass ash rich in alkali metal, and extracting the mixture to obtain a biomass ash extracting solution and dealkalized biomass ash solid residues;
(5) uniformly mixing and stirring the straw-red mud mixed powder in the step (3) and the biomass ash extracting solution in the step (4) to obtain a pasty mixture; and
(6) carrying out co-pyrolysis on the pasty mixture in the step (5) under a protective atmosphere at a pyrolysis temperature of 400° C. to 1,000° C. (preferably 500° C. to 850° C.), and carrying out heat preservation for 10 minutes to 5 hours (preferably 30 minutes to 3 hours); and washing magnetic straw biochar produced by co-pyrolysis with water until the magnetic straw biochar is neutral to obtain the red mud enhanced magnetic straw biochar material.

Specifically, in the step (1), the straws are naturally air-dried or artificial dried until a water content is lower than 5 wt %, and the dried straws are crushed to below 120 meshes; and in the step (2), a Fe₂O₃ content in the red mud is greater than or equal to 30 wt %, and the red mud is dried until a water content is lower than 2 wt %. The red mud and the straws are dried before ball milling to avoid residual moisture from causing adhesion to a tank, thus affecting the effect.

Specifically, in the step (3), the powdery red mud is mixed with the straws by ball milling with the powdery red mud accounting for a mass ratio of 5% to 85% of the total mixture and preferably 10% to 65%; and the mixing lasts for 4 hours to 72 hours, and preferably 12 hours to 24 hours. Particles of two materials are mixed and embedded with each other in the mechanical process by ball milling.

Specifically, in the step (4), the biomass ash rich in alkali metal is selected from any one or a mixture of two or more of broadleaf ash, wheat straw ash, rice husk ash, cotton stalk ash and sunflower stalk ash; the biomass ash and the water are mixed according to a mass ratio of 1:0.5 to 4 (preferably 1:1 to 1.5), and the extracting adopts solid-liquid mixing followed by filtration and separation, or column percolation extracting; the biomass ash extracting solution produced after extracting is rich in alkaline substances, and is used for modifying and improving a quality of straw biochar; and the remaining low-alkali solid is rich in phosphorus, magnesium and soluble silicon, easily soluble substances are reduced, and the dealkalized biomass ash solid residues produced are used as a fertilizer, thus reducing the risk of soil salinization.

Preferably, in the step (5), the straw-red mud mixed powder and the biomass ash extracting solution are mixed according to a mass ratio of 1:0.2 to 4, the straw-red mud mixed powder and the biomass ash extracting solution are uniformly stirred to form the pasty mixture, and the pasty mixture is allowed to stand for 0.5 hour to 2 hours for full solid-liquid reaction, so that ions in the biomass ash extracting solution and soluble alkali metal in the red mud diffuse into straw particles with the help of water.

Preferably, in the step (6), the protective atmosphere is nitrogen, a flow rate of the nitrogen per minute is 3% to 30% of a volume of a furnace, so as to avoid oxygen from entering the furnace to oxidize a product, and avoid an excessively high flow rate from causing the decline of the yield at the same time.

During the co-pyrolysis reaction, alkali reacts with carbon to promote pore development of the biochar; and iron oxide in red mud is reduced to produce ferrosoferric oxide and elemental iron, and the ferrosoferric oxide and the elemental iron are sources of material magnetism, and endow the biochar material with magnetism. Meanwhile, the alkali metal, and Fe, Si, Al, Na, Ti and other elements in the red mud are subjected to solid-phase reaction with the biochar during pyrolysis to form a submicronic homogeneous structure, thus increasing adsorption sites of the biochar.

Further, the red mud-enhanced magnetic straw biochar material prepared by the preparation method above is also within the scope of protection of the present invention.

Further, the present invention further claims to protect an application of the red mud enhanced magnetic straw biochar material above in wastewater treatment as an adsorbent.

Further, the present invention claims to protect an application of the red mud-enhanced magnetic straw biochar material above for removing a fluoroquinolone antibiotic in water in wastewater treatment as an adsorbent, which specifically comprises the following steps of:
S1: uniformly mixing the red mud-enhanced magnetic straw biochar material and a wastewater to be treated, and fully adsorbing a fluoroquinolone antibiotic in the wastewater;
S2: separating the red mud enhanced magnetic straw biochar material adsorbed with the fluoroquinolone antibiotic from the treated wastewater through a magnetic force;
S3: pyrolyzing and regenerating the separated red mud enhanced magnetic straw biochar material adsorbed with the fluoroquinolone antibiotic at 300° C. to 700° C. under a protective atmosphere, and carrying out heat preservation for 10 minutes to 60 minutes; and
S4: reusing the pyrolyzed and regenerated red mud enhanced magnetic straw biochar material in the step S3 to adsorb the fluoroquinolone antibiotic in the wastewater.

In the step S3, a temperature of the pyrolyzing and regenerating should be more than 100° C. lower than an initial preparation temperature of the red mud-enhanced magnetic straw biochar material, and the adsorbed fluoroquinolone antibiotic is decomposed without changing a main structure of the biochar. Meanwhile, magnetic particles partially oxidized during use are regenerated under a high-temperature reducing atmosphere.

Specifically, the fluoroquinolone antibiotic above comprises, but is not limited to, at least one of ofloxacin, norfloxacin, ciprofloxacin, pefloxacin, enoxacin, and the like.

### Beneficial Effects:

(1) The present invention improves use values and economic values of the straw biochar and the red mud, and realizes the synergistic utilization of various solid wastes. The straw biochar produced by the method is cheap, higher in performance than expensive nano-zero-valent iron composite biochar, magnetic, convenient to recover by magnetic separation after adsorption saturation, and further reused by pyrolysis, thus having an excellent reuse performance, and greatly improving an applicability and a commercial value of the straw biochar as the adsorbing material. Shandong and Henan provinces are not only granary provinces, but also aluminum industry provinces, and have large straw and red mud yields, and the method not only provides a high-value utilization way for the straws and the red mud, but also reduces greenhouse gas emission when the straws are used compared with common methods, and reduces the risk of land salinization when the biomass ash is used.
(2) According to the present invention, two solid wastes of straw and red mud are subjected to ball milling, soaking with the biomass ash extracting solution, co-pyrolysis and other treatments to homogeneously recombine iron and carbon elements in a submicronic scale, so that a large number of efficient adsorption sites are provided, an adsorption rate and an adsorption capacity of the straw biochar to the fluoroquinolone antibiotic are greatly improved, and meanwhile, the straw biochar is endowed with magnetism, which facilitates separation and recovery. The recovered adsorbent may decompose the adsorbed fluoroquinolone antibiotic by pyrolysis, and may be reused for many times to realize the treating waste with waste, thus improving an application value and an economic value of the straw biochar.
(3) According to the present invention, the used straw biochar may be pyrolyzed and regenerated through simple magnetic recovery, and the recovered product has small performance attenuation, and may be reused for many times, thus significantly reducing a use cost, and improving a product value. The adsorbed fluoroquinolone antibiotic is decomposed at the temperature of 300° C. to 700° C., the adsorption performance of the straw biochar is restored, and there is no adsorption performance attenuation after the straw biochar is reused for 10 times.

### BRIEF DESCRIPTION OF THE DRAWINGS

The present invention is further described in detail hereinafter with reference to the drawings and specific embodiments, and the advantages of the above and/or other aspects of the present invention will be clearer.

FIG. 1 is an effect diagram of an antibiotic removal rate of a red mud-enhanced magnetic straw biochar material in Embodiment 1.

FIG. 2 is an effect diagram of magnetic separation of the red mud-enhanced magnetic straw biochar material in Embodiment 1.

FIG. 3 is a scanning electron micrograph and an element distribution map of the red mud enhanced magnetic straw biochar material in Embodiment 1.

FIG. 4 is an effect diagram of an antibiotic removal rate of a red mud enhanced magnetic straw biochar material in Embodiment 2 after 10 cycles.

### DETAILED DESCRIPTION

The present invention may be better understood according to the following embodiments.

### Embodiment 1

### I. Preparation of Magnetic Straw Biochar

### 1. Preparation of Raw Material:

Straws were taken from wheat straws in Lianyungang, Jiangsu Province, red mud was taken from a red mud yard of an aluminium oxide enterprise in Shandong, and water used was ultra-pure water made in a laboratory. The straws were cut into sections, dried in an oven at 105° C. to a constant weight, crushed by a blade-type Chinese medicine pulverizer, and sieved by a 125 μm sieve (120 meshes). The red mud was dried in an oven at 105° C. to a constant weight, crushed by a jaw crusher, and sieved by a 50-mesh sieve. The straws and the red mud were added into a ball milling tank according to a ratio of 9:1, ground at a revolving speed of 350 rpm for 16 hours, and then taken out to form a raw material mixture A.

The wheat straws were burned in a muffle furnace at 1,000° C. to a constant weight to obtain biomass ash. The biomass ash and the water were mixed in a beaker at a ratio of 1:4, heated to 60° C., stirred and mixed for 2 hours, and then filtered for solid-liquid separation, and the obtained solution was a biomass ash extracting solution B.

### 2. Preparation of Magnetic Biochar

The raw material mixture A and the biomass ash extracting solution B were uniformly mixed and stirred with a glass rod in a quartz glass boat according to a mass ratio of 1:2, the quartz glass boat was sent into a tube furnace, the tube furnace was sealed, nitrogen was introduced at a rate of 300 ml/min to drive out oxygen in a tube, and the mixture was allowed to stand for 60 minutes to realize full solid-liquid mixing. Subsequently, the mixture was heated to 500° C. at 10° C./min, and subjected to heat preservation for 120 minutes. The mixture was taken out after being cooled with the furnace to room temperature to obtain a red mud-enhanced magnetic straw biochar material.

### 3. Adsorption of Fluoroquinolone Antibiotic

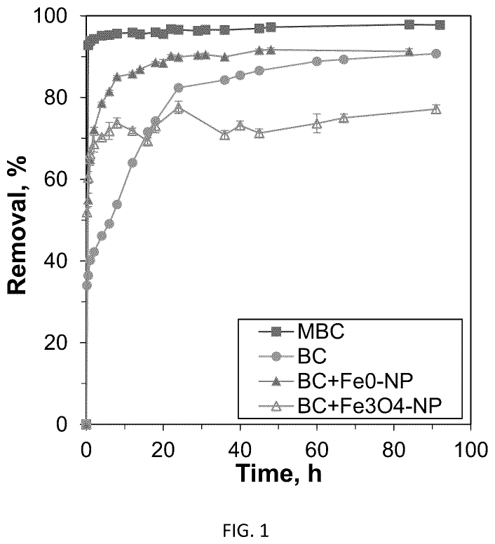

As a comparison, the red mud-enhanced magnetic straw biochar material (MBC) obtained according to the above mentioned steps in (1), wheat straw biochar (BC) prepared under the same pyrolysis conditions in (2), magnetic biochar (BC+Fe⁰—NP) obtained by chemical precipitation of zero-valent iron nanoparticles on the wheat straw biochar in (3), and magnetic biochar (BC+Fe₃O₄—NP) obtained by chemical precipitation of ferrosoferric oxide nanoparticles on the wheat straw biochar in (4) were prepared, and 0.1 g of MBC, BC, BC+Fe0−NP and BC+Fe₃O₄—NP were taken and added into 50 ml of solution with a concentration of 20 mg/L ofloxacin respectively, three parallel experiments were conducted in each group, and each group was mixed in a shaking table, and regularly sampled to monitor a change of an ofloxacin concentration. Results were shown in FIG. 1.

A preparation method of the magnetic biochar (BC+Fe⁰—NP) was that: 1.0 g of BC and 0.15 g of FeCl₃·6H₂O were added into 75% ethanol, stirred and mixed for 60 minutes, slowly dropwise added with 10 ml of 10 g/I NaBH₄ solution under protection of nitrogen, continuously stirred for 30 minutes, and then filtered and separated to obtain the BC+Fe⁰—NP.

A preparation method of the magnetic biochar (BC+Fe₃O₄—NP) was that: 0.1 g of FeCl₃·6H₂O and 0.0368 g of FeCl₂·4H₂O were dissolved in distilled water under protection of nitrogen, added with 1.0 g of BC, mechanically stirred and mixed for 30 minutes, dropwise added with ammonia water to adjust a pH value to be 10 to 11, heated to 80° C., continuously stirred for 30 minutes, continuously introduced with nitrogen and added with ammonia water in this period to maintain the pH value to be 10 to 11, and then filtered and separated to obtain the BC+Fe₃O₄—NP.

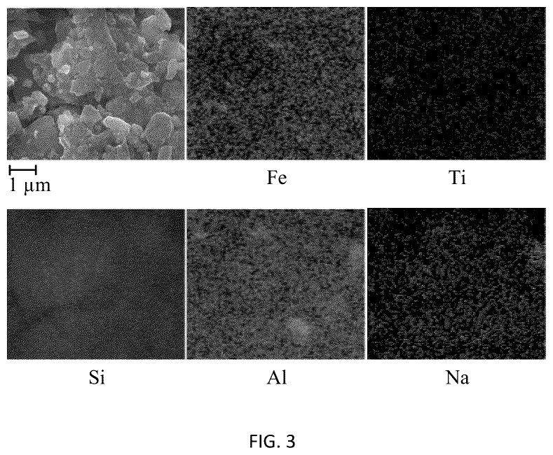

It could be seen that an antibiotic removal rate of the wheat straw biochar (BC) obtained by direct pyrolysis could not exceed 90%, equilibrium time was long, and curve growth was slow; the biochar modified by chemical precipitation of expensive nano-zero-valent iron or ferrosoferric oxide particles (BC+Fe⁰—NP and BC+Fe₃O₄—NP) could significantly shorten the equilibrium time and improve treatment efficiency, but could not improve the removal rate; and iron oxide in the red mud was reduced to produce ferrosoferric oxide and elemental iron, and the ferrosoferric oxide and the elemental iron were sources of material magnetism, and endowed the biochar materials with magnetism. Meanwhile, as shown in FIG. 3, alkali metal, and Fe, Si, Al, Na, Ti and other elements in the red mud were subjected to solid-phase reaction with the biochar during pyrolysis to form a submicronic homogeneous structure, thus increasing adsorption sites of the straw biochar. In an application of the red mud-enhanced magnetic straw biochar material (MBC) obtained by the present invention, the adsorption efficiency and the removal rate were both greatly improved, and an effect better than that of an expensive nano material was obtained by using the solid waste as raw material.

### 4. Magnetic Separation

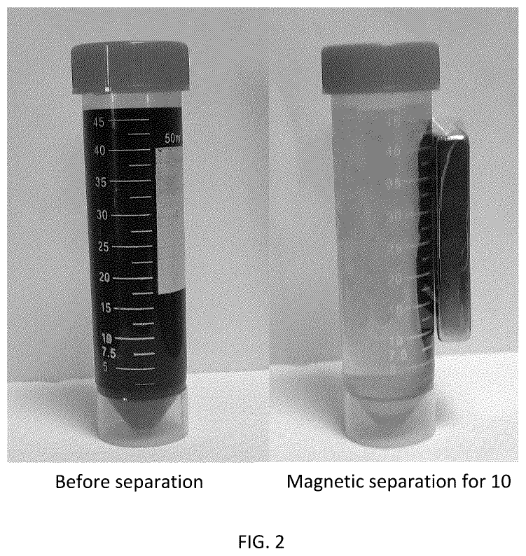

After the experiment was completed, the red mud-enhanced magnetic straw biochar material could be subjected to solid-liquid separation by a magnet to facilitate recycling, as shown in FIG. 2. It could be seen that the red mud enhanced magnetic straw biochar material adsorbed with the fluoroquinolone antibiotic was well separated from water through magnetism generated by a simple magnet.

### Embodiment 2

### I. Preparation of Magnetic Straw Biochar

### 1. Preparation of Raw Material:

Straws were taken from wheat straws in Nanjing, Jiangsu Province, red mud was taken from a red mud outlet of a plate-and-frame filter press of an aluminium oxide enterprise in Henan, and water used was ultra-pure water made in a laboratory. The straws were cut into sections, dried in an oven at 105° C. to a constant weight, crushed by a blade-type Chinese medicine pulverizer, and sieved by a 125 μm sieve (120 meshes). The red mud was dried in an oven at 105° C. to a constant weight, crushed by a jaw crusher, and sieved by a 50-mesh sieve. The straws and the red mud were added into a ball milling tank according to a ratio of 2:1, ground at a revolving speed of 350 rpm for 5 hours, and then taken out to form a raw material mixture A′.

A mixture of sycamore branches and leaves was burned in a muffle furnace at 900° C. to a constant weight to obtain biomass ash. The biomass ash was put into an organic glass column, the water was pumped into the column from bottom to top by a peristaltic pump for percolation by extracting, and an extracting solution with the same weight as the biomass ash in a previous section was collected and marked as a biomass ash extracting solution B′.

### 2. Preparation of Magnetic Biochar

The raw material mixture A′ and the biomass ash extracting solution B′ were uniformly mixed and stirred with a glass rod in a quartz glass boat according to a mass ratio of 1:0.5, the quartz glass boat was sent into a tube furnace, the tube furnace was sealed, nitrogen was introduced at a rate of 300 ml/min to drive out oxygen in a tube, and the mixture was allowed to stand for 60 minutes to realize full solid-liquid mixing. Subsequently, the mixture was heated to 800° C. at 10° C./min, and subjected to heat preservation for 120 minutes. The mixture was taken out after being cooled with the furnace to room temperature to obtain a red mud-enhanced magnetic straw biochar material.

### 3. Adsorption of Fluoroquinolone Antibiotic

0.3 g of red mud-enhanced magnetic straw biochar material was added into 50 ml of solution with a concentration of 20 mg/L norfloxacin antibiotic, and balanced in a shaking table for 24 hours, then a norfloxacin antibiotic concentration was measured, and a removal rate was calculated.

### 4. Recycling

After the adsorption experiment was completed, the used red mud enhanced magnetic straw biochar material was separated through a magnetic force, and pyrolyzed and regenerated at 700° C. in a tube furnace under protection of nitrogen. The regenerated red mud-enhanced magnetic straw biochar material was applied to the adsorption of the norfloxacin antibiotic.

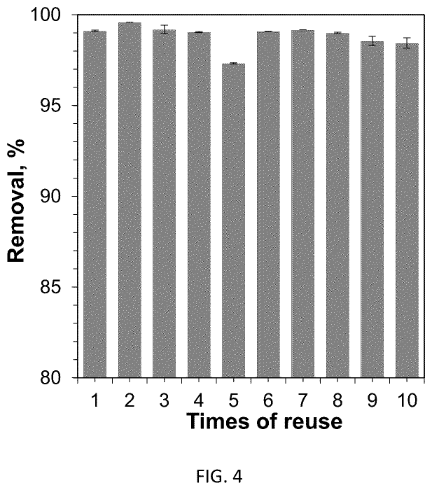

The steps 3 and 4 were repeated. It could be seen from FIG. 4 that, after 10 times of reuse, antibiotic removal efficiency of the red mud-enhanced magnetic straw biochar material was not significantly reduced, which indicated that performance of repeatedly regenerated red mud-enhanced magnetic straw biochar material was stable, and a use cost could be significantly reduced.

The present invention provides an idea and a method for the preparation method and application of the red mud-enhanced magnetic straw biochar material, with many methods and ways to realize the technical solution specifically. Those described above are merely the preferred embodiments of the present invention, and it should be pointed out that those of ordinary skills in the art may further make improvements and decorations without departing from the principle of the present invention, and these improvements and decorations should also be regarded as the scope of protection of the present invention. All the unspecified components in the embodiments can be realized by the prior art.

1.-9. (canceled)

10. A preparation method of a red mud-enhanced magnetic straw biochar material, comprising the following steps of:
(1) naturally air-drying or artificial drying straws, and crushing the dried straws;
(2) drying red mud from Bayer process, and crushing the red mud into powder;
(3) mixing the crushed straws in the step (1) and the powdery red mud in the step (2) by ball milling to obtain straw-red mud mixed powder;
(4) mixing water and biomass ash rich in alkali metal, and extracting the mixture to obtain a biomass ash extracting solution and dealkalized biomass ash solid residues;
(5) uniformly mixing and stirring the straw-red mud mixed powder in the step (3) and the biomass ash extracting solution in the step (4) to obtain a pasty mixture; and
(6) carrying out co-pyrolysis on the pasty mixture in the step (5) under a protective atmosphere at a pyrolysis temperature of 400° C. to 1,000° C., and carrying out heat preservation for 10 minutes to 5 hours; and washing magnetic straw biochar produced by co-pyrolysis with water until the magnetic straw biochar is neutral to obtain the red mud-enhanced magnetic straw biochar material;
wherein, in the step (1), the straws are naturally air-dried or artificial dried until a water content is lower than 5 wt %, and the dried straws are crushed to below 120 Meshes; and in the step (2), a Fe₂O₃ content in the red mud is greater than or equal to 30 wt %, and the red mud is dried until a water content is lower than 2 wt %;
wherein, in the step (3), the powdery red mud is mixed with the straws by ball milling with the powdery red mud accounting for a mass ratio of 5% to 85% of the total mixture, and the mixing lasts for 4 hours to 72 hours.

11. The preparation method of the red mud-enhanced magnetic straw biochar material according to claim 10, wherein, in the step (4), the biomass ash rich in alkali metal is selected from any one or a mixture of two or more of broadleaf ash, wheat straw ash, rice husk ash, cotton stalk ash and sunflower stalk ash; the biomass ash and the water are mixed according to a mass ratio of 1:0.5 to 4, and the extracting adopts solid-liquid mixing followed by filtration and separation, or column percolation extracting; and the dealkalized biomass ash solid residues produced after extracting are used as a fertilizer.

12. The preparation method of the red mud-enhanced magnetic straw biochar material according to claim 10, wherein, in the step (5), the straw-red mud mixed powder and the biomass ash extracting solution are mixed according to a mass ratio of 1:0.2 to 4, the straw-red mud mixed powder and the biomass ash extracting solution are uniformly stirred to form the pasty mixture, and the pasty mixture is allowed to stand for 0.5 hour to 2 hours for full Solid-liquid reaction, so that ions in the biomass ash extracting solution and soluble alkali metal in the red mud diffuse into straw particles with the help of water.

13. A red mud enhanced magnetic straw biochar material prepared by the preparation method according to claim 10.

14. An application of the red mud enhanced magnetic straw biochar material according to claim 13 in wastewater treatment as an adsorbent.

15. The application according to claim 14 for removing a fluoroquinolone antibiotic in water in wastewater treatment as an adsorbent, comprising the following steps of:
S1: uniformly mixing the red mud-enhanced magnetic straw biochar material and wastewater, and fully adsorbing fluoroquinolone antibiotics in the wastewater;
S2: separating the red mud-enhanced magnetic straw biochar material adsorbed with the fluoroquinolone antibiotic from the treated wastewater through a magnetic force;
S3: pyrolyzing and regenerating the separated red-mud enhanced magnetic straw biochar material adsorbed with the fluoroquinolone antibiotic at 300° C. to 700° C. under a Protective atmosphere, and carrying out heat preservation for 10 minutes to 60 minutes; and
S4: reusing the pyrolyzed and regenerated red mud-enhanced magnetic straw biochar material in the step S3 to adsorb the fluoroquinolone antibiotic in wastewater.

16. The application according to claim 15, wherein the fluoroquinolone antibiotic comprises at least one of ofloxacin, norfloxacin, ciprofloxacin, pefloxacin and enoxacin.
